(19) United States
(12) Patent Application Publication
(10) Pub. No.: US 2005/0189314 A1
(43) Pub. Date: Sep. 1, 2005

(54) Attachable grip for bottles

(76) Inventor: Darcy Carbone, Medford, MA (US)

Correspondence Address: GUERIN & RODRIGUEZ, LLP, 5 MOUNT ROYAL AVENUE, MOUNT ROYAL OFFICE PARK, MARLBOROUGH, MA, 01752, US

(21) Appl. No.: 10/790,594

(22) Filed: Mar. 1, 2004

(51) Int. Cl. B65D 23/10; B67D 1/00; A47G 19/00; B65D 83/00

(52) U.S. Cl. 215/396

(57) ABSTRACT

Described is an attachable bottle grip for assisting a user in dispensing the contents of a bottle. The bottle grip includes a patch having an adhesive on one surface for attaching the patch to the bottle. A textured surface on the opposite side of the patch assists the user in grasping the bottle while dispensing the contents of the bottle. The perimeter of the patch can be shaped to match the contour of the bottle. The patch can include a protective layer for protecting the adhesive prior to attaching the patch to the bottle and can be shaped and marked to indicate the contents of the bottle.

### FIELD OF THE INVENTION

The invention relates generally to a grip for a bottle. In particular, the invention relates to an attachable bottle grip for preventing a bottle from slipping while a user is dispensing the contents of the bottle.

### BACKGROUND

Various types of consumer products for personal use are sold in bottles. The bottles are frequently equipped with a pump or similar device for dispensing the contents of the bottle. The bottles typically are fabricated from glass or plastic and have a smooth outer surface. Contents of the bottle may include fluid which makes the bottle slippery and difficult to hold if the fluid is inadvertently deposited on the outer surface of the bottle. Some personal care products, such as lotions and skin treatments, are intended for application to the hands of the consumer. Often such products are provided in bottles which have a pump dispenser located at the top of the bottle. The user grips the body of the bottle with one hand and reaches upward with one or more fingers to depress the pump dispenser. If the user's hand is wet, for example, from previously applied lotion, the downward force required to operate the pump dispenser can cause the bottle to slip from the hand, possible resulting in damage to the bottle and loss of contents.

Bottles provided by different manufacturers for similar products often have similar shapes and sizes. Moreover, the contents of the bottles are not always easily identified by labeling or marking the bottle. Thus, a user desiring to apply hand lotion may have difficulty determining which bottle has the desired contents if the appropriate bottle is located along side similarly shaped bottles having other contents. In some instances, multiple users may keep identical products in a common location. A user may want to prevent others from using the contents of the user's bottles, especially if the associated product is expensive or not readily available for purchase.

Thus there exists a need a bottle grip that provides for a secure grip of a user while dispensing the contents of the bottle. The bottle grip should be easy to apply and remain attached to the bottle throughout its useful life. Moreover, there exists a need to identify and distinguish similarly shaped bottles. The present invention satisfies these needs and provides additional advantages.

### SUMMARY OF THE INVENTION

In one aspect, the invention features an attachable bottle grip having a patch with a first surface, a second surface and a perimeter. The first surface is opposite the second surface and includes an adhesive for attaching the patch to a bottle. The second surface has a rough texture to aid a grasp of a user when dispensing at least a portion of the contents of the bottle.

In another aspect, the invention features an apparatus for assisting a user in dispensing contents. The apparatus includes a bottle, a dispensing mechanism and a patch. The bottle has an inner volume to hold the contents, an outer surface to be gripped by the user and an opening. The dispensing mechanism is affixed to the bottle and extends through the bottle opening. The dispensing mechanism provides at least a portion of the contents to the user when activated by the user. The patch is affixed to the outer surface of the bottle and includes a textured outer surface to aid the grip of the user when dispensing the contents from the bottle.

### BRIEF DESCRIPTION OF THE DRAWINGS

The above and further advantages of this invention may be better understood by referring to the following description in conjunction with the accompanying drawings, in which like numerals indicate like structural elements and features in the various figures. The drawings are not necessarily to scale, emphasis instead being placed upon illustrating the principles of the invention.

FIGS. 1A and 1B are front view and side view illustrations, respectively, of a personal care product bottle having a pump dispenser.

FIGS. 2A and 2B are front view and side view illustrations, respectively, of an embodiment of an apparatus for assisting a user in dispensing contents of a bottle in accordance with the invention.

FIGS. 3A and 3B are side view and top view illustrations, respectively, of an embodiment of an attachable bottle grip in accordance with the invention.

FIG. 4 is an illustration of a sheet containing multiple attachable bottle grips in accordance with an embodiment of the invention.

### DETAILED DESCRIPTION

In brief overview, the invention relates to an attachable bottle grip which can be easily applied to a bottle to help a user grip the bottle. Advantageously, the attachable bottle grip provides for a secure grip while the user dispenses the contents (i.e., product) from the bottle even if the contents coat the outer surface of the bottle or have been applied to the user's hands. The attachable bottle grip can be fabricated with various designs and identifiers on the outer surface of the grip to identify the contents or the user associated with a specific bottle.

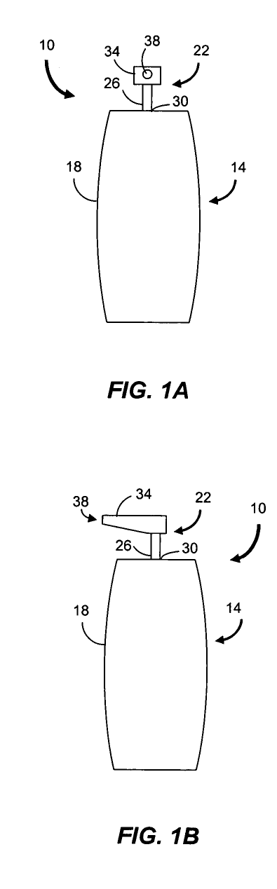

Referring to FIGS. 1A and 1B, a personal care product 10 includes a bottle 14 containing a product, or contents, to be dispensed by a user. Contents can include fluids such as lotions, perfume, liquid soap and the like that at least partially fill an inner volume enclosed by the bottle 14. As used herein, dispensing contents means dispensing any portion of the contents or all of the contents from the bottle. The bottle 14 has an outer surface 18 having a contour (i.e., shape). As illustrated, the bottle 14 encompasses a substantially cylindrical volume, although the radius of the cylinder gradually decreases with distance from the midpoint along the length of the cylinder. A pump dispenser 22 at the top of the bottle 14 includes a stem 26 extending vertically upward through a bottle opening 30 and a snout 34 extending laterally from the top of the stem section 26. During use, a user grips the outer surface 18 of the bottle 14 with one hand and reaches upward with one or more fingers to depress the snout 34. Contents are dispensed from an opening 38 in the snout 34. If the user's hand is wet, for example, from previously applied contents, the downward force applied to operate the pump dispenser 22 can cause the bottle 14 to slip from the hand, risking damage to the bottle 14 and loss of the contents.

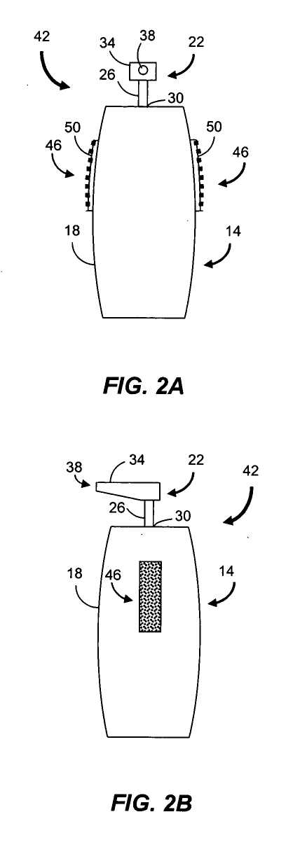

FIGS. 2A and 2B are illustrations of an embodiment of an apparatus 42 for assisting a user in dispensing the contents according to the invention. The apparatus 42 includes a bottle 14 and a pump mechanism 22 similar to that shown in FIGS. 1A and 1B. The apparatus also includes two patches 46 secured to the outer surface of the bottle 14. The patches 46 are located diametrically opposite each other (i.e., on opposite sides of the bottle). In other embodiments, other numbers of patches 46 are used. For example, a single patch 46 can be arranged circumferentially around the bottle 14.

Each patch 46 has an outer surface 50 with a rough texture to aid the user in grasping the bottle 14 while operating the pump mechanism 22 to dispense the contents. The rough texture can be achieved using raised features (e.g., bumps), dimples or a combination of bumps and dimples along the outer surface to enhance the grasp of the user. In addition, the patch 46 can be constructed from a material that is resistant to coating by the contents of the bottle 14.

Although the illustrated embodiment shows a bottle 14 having circular symmetry, the present invention contemplates any shape of bottle, including shapes that are not radially or circularly symmetric. Other types of dispensing mechanisms, such as spray nozzles, can be used in place of the pump dispenser 22. Moreover, the bottle 14 can be fabricated from any of a variety of materials, including glass and plastic.

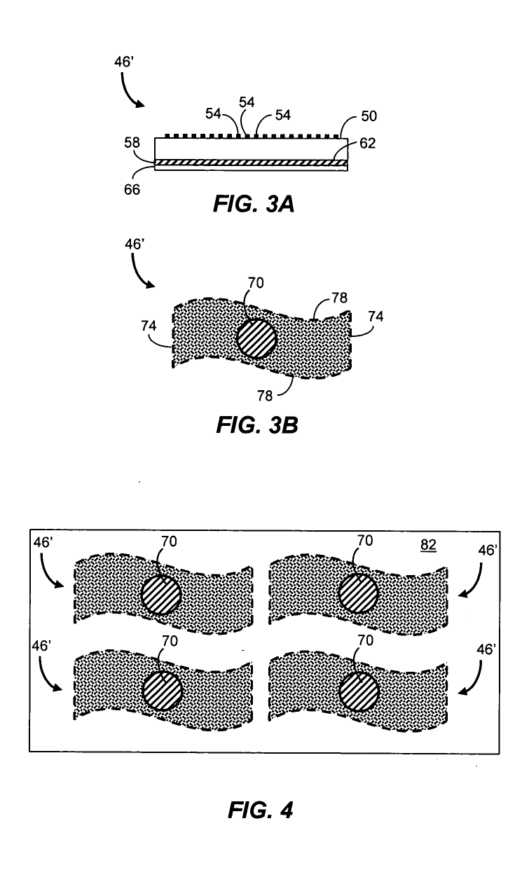

FIGS. 3A and 3B illustrate an edge view and a top view, respectively, of an attachable bottle grip 46′ according to an embodiment of the invention. The grip 46′ is fabricated as a patch from a flexible material and includes a plurality of bumps 54 on the outer surface 50 to generate a rough texture to enhance the user's grip. An adhesive layer 58 coats the inner surface 62 of the patch 46′. A protective layer 66 is fabricated from a material that resists sticking to the adhesive layer 58. The protective layer 66 covers the adhesive layer 66 to prevent the patch 46′ from sticking to other objects before application to a bottle. The protective layer 66 is removed from the patch 46′ just before the user attaches the patch 46′ to the bottle.

The attachable bottle grip 46′ can be manufactured in any of a variety of colors, or may include a combination of colors. In the illustrated embodiment, the outer surface 50 includes a marking 70, such as a graphical design or emblem, to designate the manufacturer of the product or the contents of the bottle. For example, if the product is a strawberry scented lotion, the marking 70 may include an image of a strawberry. Optionally, the marking 70 can identify the owner of the product. The marking 70 can include any combination of colors and can include depressions or raised features on the outer surface 50.

The patch 46′ includes a perimeter (indicated by dashed lines) which defines any of a variety of shapes. In the illustrative embodiment, the perimeter includes two parallel straight sides 74 and two parallel wavy sides 78. Because products can be sold in bottles of varying size and contours, a manufacturer may desire a perimeter shaped to match, or complement, a distinctive contour of its bottles. In some instances the perimeter of the patch 46′ may require a specific shape to allow the patch 46′ to lie smooth against the outer surface 18 of the bottle. Optionally, the shape can be designed to identify the contents of the bottle or the owner of the bottle. For example, if the associated product is a scented lotion, the perimeter can resemble the shape of a strawberry.

The attachable bottle grip 46′ can be provided to a user in a variety of formats. FIG. 4 illustrates a sheet 82 containing four of the grips 46′ illustrated in FIGS. 3A and 3B. Each grip 46′ is peeled away from the sheet 82 just prior to its application to the bottle 14. The sheet format is desirable if the attachable bottle grips 46′ are sold with the product. Alternatively, the grips 46′ can be provided in a roll. The roll format is advantageous if a consumer uses the same type of grip 46′ for a large number of bottles.

While the invention has been shown and described with reference to specific preferred embodiments, it should be understood by those skilled in the art that various changes in form and detail may be made therein without departing from the spirit and scope of the invention as defined by the following claims.

1. An attachable bottle grip comprising a patch having a first surface, a second surface and a perimeter, the first surface being opposite the second surface and having an adhesive applied thereto for attaching the patch to a bottle, the second surface having a rough texture to aid a grasp of a user when dispensing at least a portion of the contents of the bottle.

2. The attachable bottle grip of claim 1 wherein the second surface has a plurality of raised features to aid the grasp of the user.

3. The attachable bottle grip of claim 1 wherein the second surface has a plurality of dimples to aid the grasp of the user.

4. The attachable bottle grip of claim 1 wherein the perimeter of the patch is shaped to accept a contour of the bottle.

5. The attachable bottle grip of claim 1 further comprising a removable protective layer adjacent to the first surface for protecting the adhesive prior to attachment of the patch to the bottle.

6. The attachable bottle grip of claim 1 wherein the second surface has a marking identifying the contents of the bottle.

7. The attachable bottle grip of claim 1 wherein the perimeter of the patch is shaped to identify the contents of the bottle.

8. An apparatus for assisting a user in dispensing contents, the apparatus comprising:
a bottle having an inner volume to hold the contents, an outer surface to be gripped by the user and an opening;
a dispensing mechanism affixed to the bottle and extending through the opening, the dispensing mechanism providing at least a portion of the contents to the user when activated by the user; and
a patch affixed to the outer surface of the bottle, the patch having a textured outer surface to aid the grip of the user when dispensing the contents.

9. The apparatus of claim 8 wherein the dispensing mechanism comprises a pump mechanism.

10. The apparatus of claim 8 wherein the dispensing mechanism comprises a spray nozzle.

11. The apparatus of claim 8 wherein the patch has an adhesive layer in contact with the outer surface of the bottle.

12. The apparatus of claim 8 wherein the bottle is a glass container.

13. The apparatus of claim 8 wherein the bottle is a plastic container.

14. The apparatus of claim 8 wherein the patch has a perimeter to complement a contour of the bottle.

15. The apparatus of claim 8 wherein the patch is affixed to the bottle at a first location and further comprising another patch affixed to the bottle at a second location.

16. The apparatus of claim 15 wherein the first location is diametrically opposite the second location.
